(19) United States
(12) Patent Application Publication
(10) Pub. No.: US 2007/0153637 A1
(43) Pub. Date: Jul. 5, 2007

(54) Time indicator

(76) Inventor: Yu-Pao Chen, Hsintien City (TW)

Correspondence Address: Rabin & Berdo, P.C., Suite 500, 1101 14th Street, Washington, DC, 20005, US

(21) Appl. No.: 11/325,467

(22) Filed: Jan. 5, 2006

(51) Int. Cl. G04B 19/32

(52) U.S. Cl. 368/226

(57) ABSTRACT

A time indicator has a timing unit and colored illuminating unit, the timing unit can calculate time as a common clock and the colored illuminating unit provides different colors at different time period, driven by the timing unit. People who just want to know which period of time but not accurate time can get the information more conveniently than a common clock or watch.

### BACKGROUND OF THE INVENTION

1. Field of the Invention

The present invention relates to a time indicator, and particularly relates to a time indicator that can provide different colors at different period of time.

2. Description of the Related Art

Conventional time indicators, such as clocks, watches can show time accurately, but sometimes, people just want to know which period of time instead of accurate time. For instance, when people are shopping for a while, they wonder which period of time to decide whether still go on or not; when people relieve nature in the night, they may wonder which period of time to know how long for sleeping. In a dark condition, they have to find a watch and turn on the light to clearly see hands on the watch, which is inconvenient.

Therefore, the invention provides a time indicator to mitigate or obviate the aforementioned problems.

### SUMMARY OF THE INVENTION

The main objective of the present invention is to provide a time indicator comprised of a timing unit and a colored illuminating unit. The colored illuminating unit will shown a certain color to present a certain period of time, whereby people can easily know which period of time.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a time indicator in accordance with this invention;

FIG. 2 is a circuit diagram in the time indicator in FIG. 1;

FIG. 3 is a sequence diagram showing the operation of the LEDs in FIG. 1; and

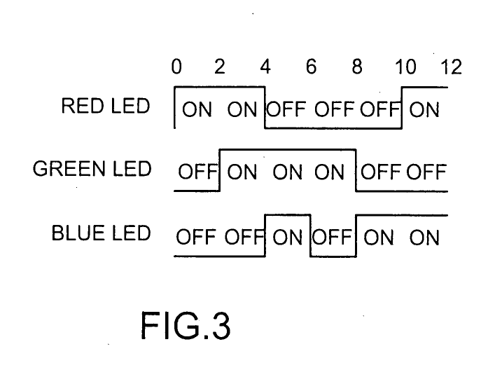

FIG. 4 is a side view of another embodiment of a time indicator in accordance with this invention.

### DETAILED DESCRIPTION OF THE PREFERRED EMBODIMENT

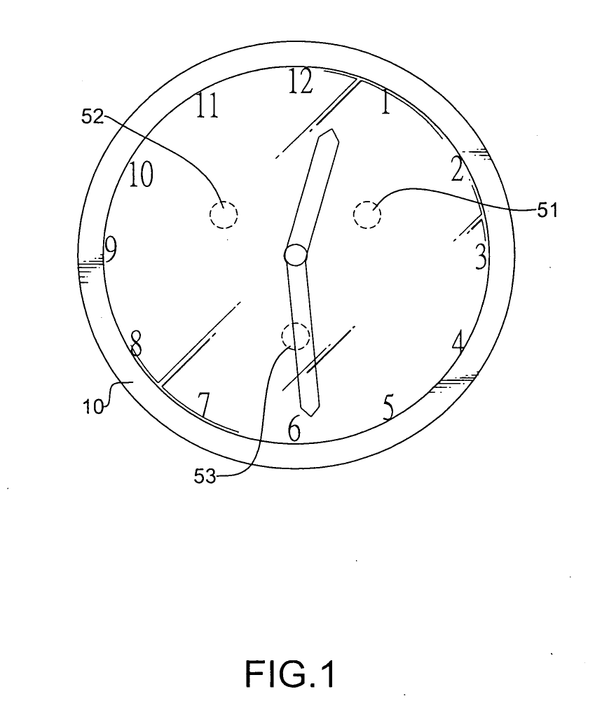

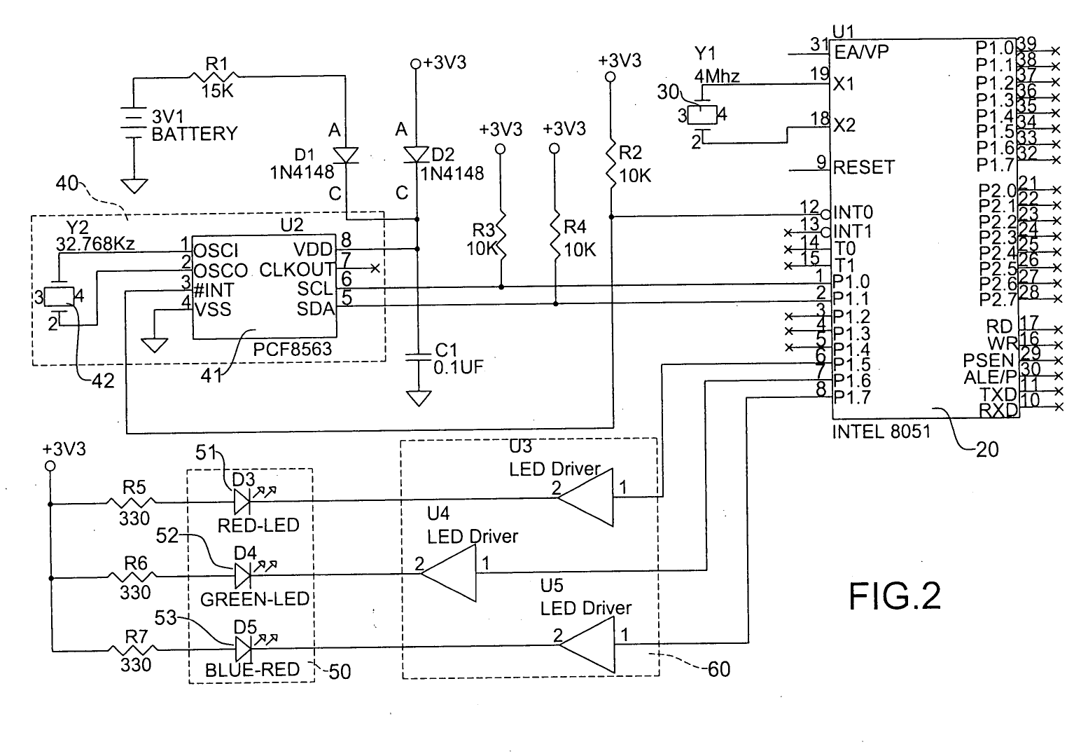

With reference to FIGS. 1-2, a time indicator is a clock (10) or a watch with a cloudy surface, and the clock (10) has an integrated circuit therein, as shown in FIG. 2, which has a timing unit that is running electrically or mechanically; a colored illuminating unit having luminous elements driven by the timing unit.

The timing unit is comprised of a Central Processing Unit (CPU) (20) and a time pulse unit (40). An INTEL 8051 IC is applied as CPU (20) in this embodiment having multiple pins, wherein the eighth and the ninth pins X1, X2 are connected to a first quartz oscillator (30), which provides time pulse signals to drive the CPU (20). The time pulse unit (40) has a time pulse processor (41) and a second quartz oscillator (42), the time pulse processor (41) is a PCF8563 IC having multiple pins, and the first and second pins OSC1, OSCO are connected to the second quartz oscillator (42), the fifth and sixth pins SDA, SCL are connected to the CPU (20).

The colored illuminating unit (50) has an LED driving unit (60) and Light Emitting Diodes (LED) providing three primary colors respectively, i.e. a RED LED (51), a GREEN LED (52), and a BLUE LED (53), and they provide a lot of colors by different combination. The color unit (50) is connected to the sixth, seventh and eighth pins of the CPU (20) through the LED driving unit (60).

A small current is enough to activate the CPU (20), but the colored illuminating unit (50) requires a much bigger current, so the LED driving unit (60) is used to magnify the current to activate the colored illuminating unit (50).

The second quartz oscillator (42) in the time pulse unit (40) sends oscillator signals to the time pulse processor (41) continuously, and the time pulse processor (41) accordingly sends sequence signals to the CPU (20) continuously. Then, the CPU (20) receives and accumulates the sequence signals, when the sequence signals are accumulated to a certain period of time. For example, two hours in this embodiment, the CPU (20) will send a driving signal to the LED driving unit (60) and the colored illuminating unit (50), the colored illuminating unit (50) further decides which LED is lighted on, and which LED is lighted off to assume a certain color, according to the certain time period. In this embodiment, time periods are defined based on chromatogram order, no matter in the day or in the night, red presents zero o'clock to one to two, yellow presents two o'clock to one to four, baby blue presents four o'clock to one to six, green presents six o'clock to one to eight, blue presents eight o'clock to one to ten, and purple presents ten o'clock to one to twelve. Of course, the color definition can be changed by manufacturer.

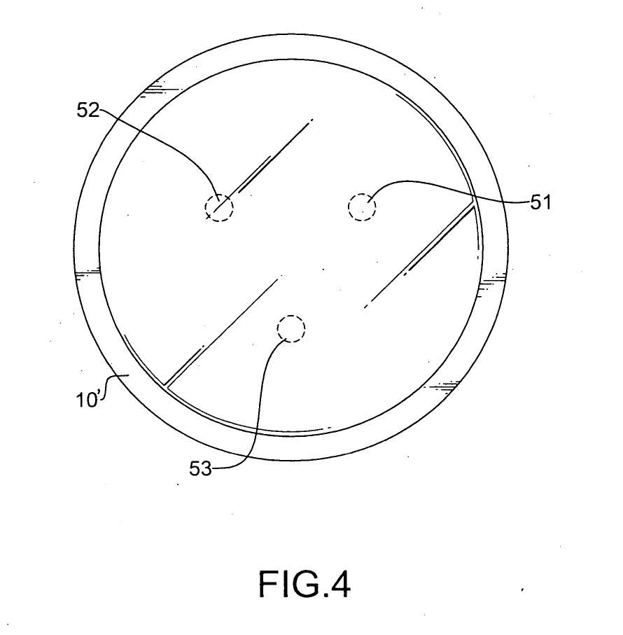

With reference to FIG. 4, it is a second embodiment of this invention. The time indicator is still a clock, but with no pointer and numbers on surface, only the color shown on the surface shows off which period of time now.

The LEDs (51), (52), (53) can also be replaced by bulbs or other illuminating source.

So the time indicator of this invention shows people which period of time now by showing one of colors on the surface that can be clearly seen in a dark condition and a decorative effect is also provided.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A time indicator comprising:
a timing unit;
a colored illuminating unit having multiple illuminating sources of different colors, wherein the colored illuminating unit is electrically connected to and controlled by the timing unit.

2. The time indicator as claimed in claim 1, wherein the timing unit has a CPU, a time pulse unit, and the colored illuminating unit has LEDs and an LED driving unit.

3. The time indicator as claimed in claim 2, wherein the CPU has multiple pins, a first oscillator is connected to the CPU to provide time pulse signals; the time pulse unit has a second oscillator and a time pulse processor with multiple pins, some of the pins are connected with the second oscillator, and some of the pins are connected to the CPU; the colored illuminating unit has at least two LEDs of different colors, which are further connected to the CPU through an LED driving unit, which magnify the current to activate the LED.

4. The time indicator as claimed in claim 3, wherein the oscillator is a quartz oscillator.

5. The time indicator as claimed in claim 2, wherein the colored illuminating unit has a red LED, a green LED, and a blue LED.

6. The time indicator as claimed in claim 1, wherein the timing unit is a clock.

7. The time indicator as claimed in claim 1, wherein the timing unit is a watch.
